(19) United States
(12) Patent Application Publication
(10) Pub. No.: US 2015/0373095 A1
(43) Pub. Date: Dec. 24, 2015

(54) METHOD AND APPARATUS FOR DETERMINING SERVICE QUALITY PROFILE ON DATA DISTRIBUTION SERVICE

(71) Applicant: Electronics and Telecommunications Research Institute, Daejeon (KR)

(72) Inventors: Kyeong Tae KIM, Daejeon (KR); Kyung Il KIM, Daejeon (KR); Yong Yeon KIM, Daejeon (KR); Je Man PARK, Gwangju-si (KR); Soo Hyung LEE, Daejeon (KR); Hyung Kook JUN, Daejeon (KR); Won Tae KIM, Asan-si (KR)

(21) Appl. No.: 14/515,258

(22) Filed: Oct. 15, 2014

(30) Foreign Application Priority Data
Jun. 24, 2014 (KR) 10-2014-0077401

(51) Int. Cl. H04L 29/08

(52) U.S. Cl. CPC H04L 67/1012

(57) ABSTRACT

Provided herein a method and apparatus for determining a QoS (quality of service) profile in the data distribution service, the method including determining network environment information; and determining the QoSProfile based on the network environment information, wherein the QoSProfile includes a QoSFunction, QoSMatching, QoSStatement, QoSConstraint, and QoSCharacteristic.

### CROSS-REFERENCE TO RELATED APPLICATION

The present application claims priority to Korean patent application number 10-2014-0077401, filed on Jun. 24, 2014, the entire disclosure of which is incorporated herein in its entirety by reference.

### BACKGROUND

1. Field of Invention

Various embodiments of the present invention relate to the data distribution service, and more particularly, to a method and apparatus for determining the quality of the data distribution service.

2. Description of Related Art

DDS (Data Distribution Service) is a communication middleware having publish-subscribe specifications for a distributed environment. In order to provide the data distribution service, a data-centric publish-subscribe programming model needs to be standardized for a distributed environment.

Although conventional distributed object middleware standards such as CORBA (Common Object Request Broker Architecture) and DCOM (Distributed Component Object Model) have numerous advantages in sharing resources and object reusability, they are remote procedure call based. Therefore, they may not be suitable in an environment where massive data needs to be distributed and exchanged quickly, due to problems of transmission delay and inefficiency in bandwidth. For example, in new types of distributed multimedia applications such as VOD, video conference, and VoIP (Voice over Internet Protocol), data needs to be transmitted real time, and massive data needs to be processed continuously, but many problems may occur such as network delay due to different platform environments and too much information transmission.

An advantage of the data distribution service is that numerous users can form a dynamic network regardless of the physical network configuration, and that users can reliably transmit in real time the information they are interested in as publishers and subscribers. Due to these characteristics, OMG (Object Management Group) recommends using the data distribution service in services such as C4I, industrial automation, distributed control and simulation, communication apparatus control, sensor networks, and network management systems that require high reliability and real time transmission.

### SUMMARY

A first purpose of various embodiments of the present invention is to provide a method for determining a service quality profile in the data distribution service.

A second purpose of various embodiments of the present invention is to provide an apparatus configured to perform a method for determining a service quality profile in the data distribution service.

According to an embodiment of the present invention, there is provided a method for determining a QoS (quality of service) profile in the data distribution service, the method including determining network environment information; and determining the QoSProfile based on the network environment information, wherein the QoSProfile may include a QoSFunction, QoSMatching, QoSStatement, QoSConstraint, and QoSCharacteristic. The QoSFunction may determine the QoSCharacteristic based on the network environment information. The QoSMatching may determine a QoSRanking by measuring how much each QoSProfile satisfies QoS in a network environment where the QoSProfile is applied and a service is operated, and the QoSRanking may be computed by giving scores regarding a QoS satisfaction index through a QoSMetric. The QoSStatement may be classified into a SingleQoSStatement and CompoundQoSStatement, the SingleQoSStatement may have only one QoSConstraint, the CompoundQoSStatement may have a relationship combination of ‘and’ or ‘or’ with a plurality of SingleQoSStatements, and the QoSConstraint may include a condition that constrains the QoSCharacteristic, and an attribute value regarding the condition. The QoSCharacteristic may represent an attribute value regarding a QoSPolicy, the QoSPolicy may be defined to guarantee communication quality of real time communication between a plurality of entities, and the QoSPolicy may include information on an object where QoS is applied, and information regarding whether or not QoS is changeable.

According to an embodiment of the present invention, there is provided an apparatus for determining a QoS (Quality of Service) profile in the data distribution service, the apparatus including a processor configured to determine network environment information, the apparatus being configured to determine the QoSProfile based on the network environment information, the QoSProfile including a QoSFunction, QoSMatching, QoSStatement, QoSConstraint, and QoSCharacteristic. The QoSFunction may determine the QoSCharacteristic based on the network environment information. The QoSMatching may determine a QoSRanking by measuring how much each QoSProfile satisfies QoS in a network environment where the QoSProfile is applied and a service is operated, and the QoSRanking may be computed by giving scores regarding a QoS satisfaction index through a QoSMetric. The QoSStatement may be classified into a SingleQoSStatement and CompoundQoSStatement, the SingleQoSStatement may have only one QoSConstraint, the CompoundQoSStatement may have a relationship combination of ‘and’ or ‘or’ with a plurality of SingleQoSStatements, and the QoSConstraint may include a condition that constrains the QoSCharacteristic, and an attribute value regarding the condition. The QoSCharacteristic may represent an attribute value regarding a QoSPolicy, the QoSPolicy may be defined to guarantee communication quality of real time communication between a plurality of entities, and the QoSPolicy may include information on an object where QoS is applied, and information regarding whether or not QoS is changeable.

According to the aforementioned embodiments of the present invention, it is possible to use a method and apparatus for determining a service quality profile in the data distribution service to easily classify and combine QoS that needs to be applied and select a QoSProfile that operates the best in a current network environment, and apply the best QoSProfile selected to the data distribution service, thereby satisfying various QoS requirements related to data transmission, and guaranteeing the best performance.

### BRIEF DESCRIPTION OF THE DRAWINGS

The above and other features and advantages of the present invention will become more apparent to those of ordinary skill in the art by describing in detail embodiments with reference to the attached drawings in which:

FIG. 1 is a conceptual view illustrating a structure of DDS;

FIG. 2 is a conceptual view illustrating a middleware;

FIG. 3 is a conceptual view illustrating a communication method using DDS;

FIG. 4 is a conceptual view illustrating a QoSProfile of DDS according to an embodiment of the present invention;

FIG. 5 is a conceptual view illustrating a QoSMatching according to an embodiment of the present invention;

FIG. 6 is a conceptual view illustrating a QoSStatement according to an embodiment of the present invention;

FIG. 7 is a conceptual view illustrating QoSCharacteristic according to an embodiment of the present invention;

FIG. 8 is a flowchart of a method for determining QoS according to an embodiment of the present invention; and

FIG. 9 is a conceptual view illustrating an apparatus for determining QoS according to an embodiment of the present invention.

### DETAILED DESCRIPTION

Hereinafter, embodiments will be described in greater detail with reference to the accompanying drawings. Embodiments are described herein with reference to cross-sectional illustrates that are schematic illustrations of embodiments (and intermediate structures). As such, variations from the shapes of the illustrations as a result, for example, of manufacturing techniques and/or tolerances, are to be expected. Thus, embodiments should not be construed as limited to the particular shapes of regions illustrated herein but may include deviations in shapes that result, for example, from manufacturing. In the drawings, lengths and sizes of layers and regions may be exaggerated for clarity. Like reference numerals in the drawings denote like elements.

Terms such as ‘first’ and ‘second’ may be used to describe various components, but they should not limit the various components. Those terms are only used for the purpose of differentiating a component from other components. For example, a first component may be referred to as a second component, and a second component may be referred to as a first component and so forth without departing from the spirit and scope of the present invention. Furthermore, ‘and/or’ may include any one of or a combination of the components mentioned.

Furthermore, ‘connected/accessed’ represents that one component is directly connected or accessed to another component or indirectly connected or accessed through another component.

In this specification, a singular form may include a plural form as long as it is not specifically mentioned in a sentence. Furthermore, ‘include/comprise’ or ‘including/comprising’ used in the specification represents that one or more components, steps, operations, and elements exist or are added.

Furthermore, unless defined otherwise, all the terms used in this specification including technical and scientific terms have the same meanings as would be generally understood by those skilled in the related art. The terms defined in generally used dictionaries should be construed as having the same meanings as would be construed in the context of the related art, and unless clearly defined otherwise in this specification, should not be construed as having idealistic or overly formal meanings.

DDS (Data Distribution Service) is a reliable real time data communication middleware standard that was made by the need to standardize a data-centric program model for a distributed environment based on a publish-subscribe model. A purpose of DDS is to simplify complicated network programming to enable transmitting data regardless of the location or existence of applications that participate in the communication, thereby simplifying the design and embodiment of the distributed applications. DDS standard consists of DCPS (DDSv1.2 API Standard) that states DDS/API standard, and RTPS (RTPS v2.1 Wire Protocol Standard) that states a network layer communication protocol. DCPS (Data Centric Publisher/Subscriber) is an interface standard that provides a data exchange function based on a publish-subscribe model.

DDS forms a network data domain dynamically, and provides a data communication environment where an embedded device or mobile device can freely participate therein or withdraw therefrom, and thus DDS may be utilized as middleware suitable for the national defense field.

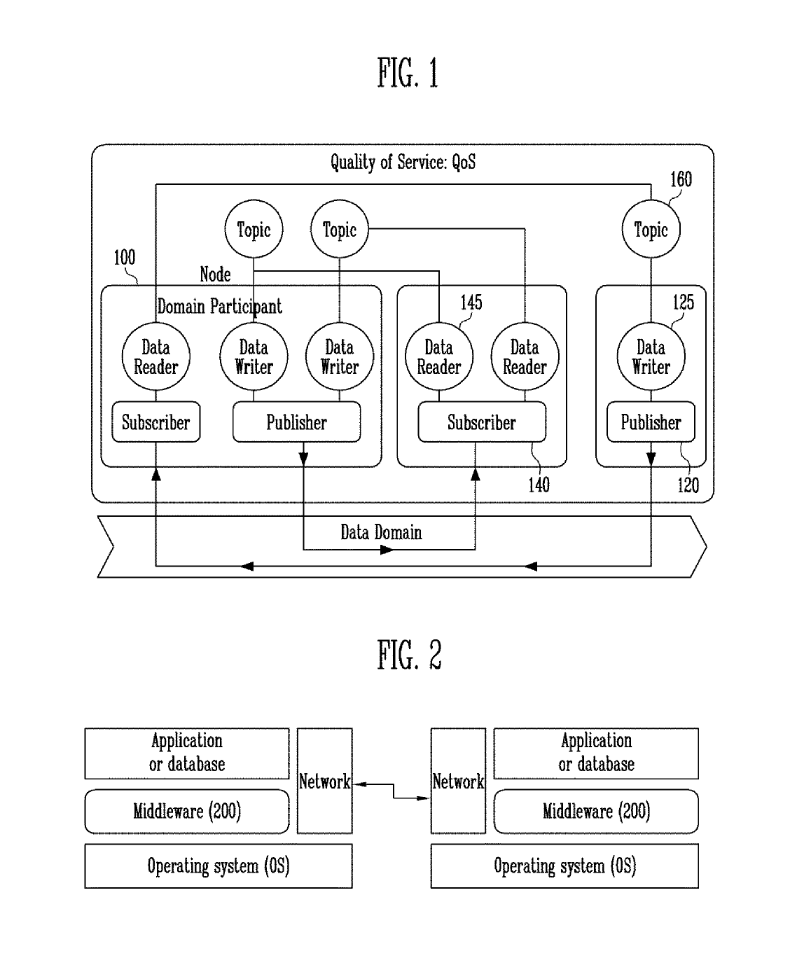

FIG. 1 is a conceptual view illustrating a structure of DDS.

Referring to FIG. 1, a domain participant 100 is an entity that represents DDS communication in an application. A publisher 120 plays the role of generating and distributing data to be transmitted. A data writer 125 may set a data value to publish the application under a topic.

A subscriber 140 receives data transmitted from the publisher through a data domain and utilizes the data received. When the application notifies that there is data that it is interested in, the data reader 145 may allow it and access data received from an annexed subscriber.

Herein, the publisher 120 and subscriber 140 must be participating in a same domain in DDS, and data must be defined in the form of a topic (concept) of DDS. A topic 160 is a concept separated from TopicDescription. It is a basic description of almost all data, and it may be published or subscribed. The topic may be a virtual data transmitting/receiving channel.

DDS presents a standard for setting QoS such as “durability, history, reliability, ownership, and deadline” for a reliable and real time transmission of topic data.

RTPS (Real Time Publish/Subscribe) is a data transmission protocol for embodying a publish-subscribe model, and it is designed to be operable even on a transmission layer that lacks reliability. RTPS states matters regarding discovery, data coding method, message format and exchange method, and transmission procedure necessary for a publisher or subscriber object defined by DCPS (Data Centric Publish Subscribe) to actually communicate.

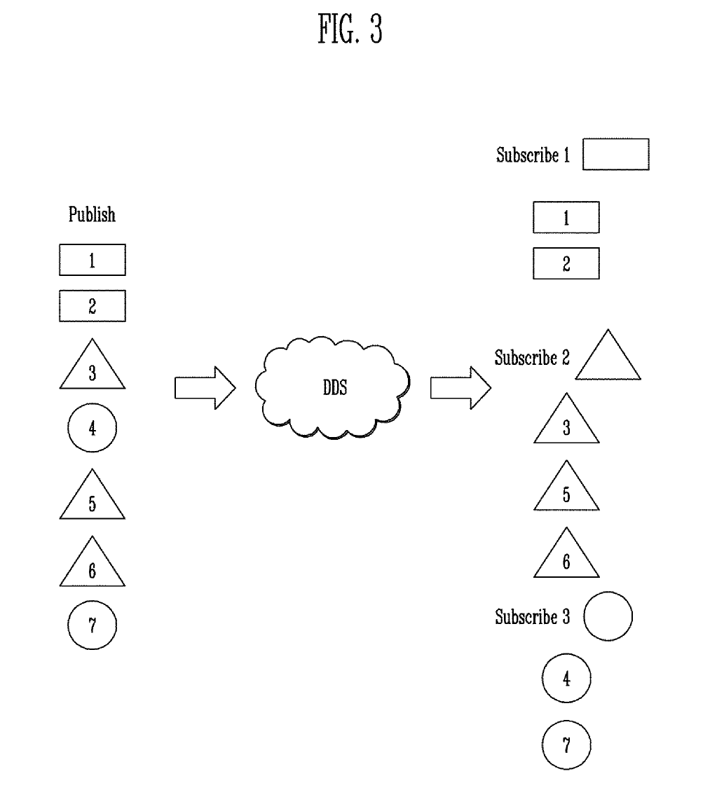

FIG. 2 is a conceptual view illustrating a middleware.

FIG. 2 illustrates the role and structure of a middleware 200. Hereinafter, a distribution service application that will be disclosed in the embodiment of the present invention may perform the role of a middleware 200.

The middleware 200 plays the role of connecting a client and a server application. A client and server is usually expressed as ‘C/S’, wherein ‘/’ may mean middleware 200. The middleware 200 provides a base structure for distributed computing, and has much effect on the development of client server technology.

Referring to FIG. 2, the middleware 200 refers to software necessary for mutual operability between different systems, and the middleware 200 may provide compatibility for a DB (database) and OS (operating system). The reason why the middleware 200 is important in the C/S technology is because not only does the logical structure (2-layer, 3-layer) of the C/S system changes depending on what kind of middleware 200 is used in constructing a system, it may also bring changes in the base structure of an entire system.

In an object-oriented system, applications exist over a wide range of area in a network in the form of distributed objects, and thus in today's distributed computing environment, it is essential to use an object middleware that provides a safe mutual communication and management service of the distributed objects. DCOM of OMG/CORBA and Microsoft, which is the current industrial standard, is the object middleware mainly used in constructing an information system. Middleware is also changing together with the development of information technology. Various models and structures are being developed from RPC (Remote Procedure Call) model which is a traditional application communication to ORB (Object Request Broker) which is an inter-object message model. It is very difficult to define the range of middleware or classify middleware. The reason is because middleware must include everything from functions of a network protocol (TCP/IP, SNA, NetBIOS) and DB driver to the role of a TP-MONITOR and distributed object.

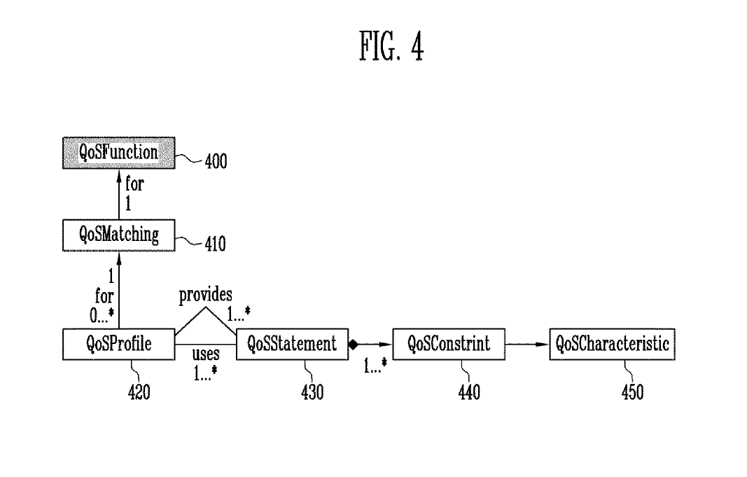

FIG. 3 is a conceptual view illustrating a method for using DDS.

Socket communication may be convenient in 1:1 communication. It may also be convenient in 1:N communication if the data type to be transmitted is the same and the client knows the address of the server. However, it may be difficult to use socket communication when sending an unspecified type of data to unspecified targets in packets.

A DDS middleware can resolve this problem at the middleware level. Therefore, a developer becomes able to write an application program without having to deeply think about the network program. A socket transmits and receives data in a send/recv method.

DDS may transmit and receive a topic (packet) in a publish-subscribe method.

First of all, at a publisher side, data to be transmitted may be defined based on ‘MDSTypedata_mds;,MDSTypedatakey_mds;’, and then a setting for communication may be made, and then the data may be transmitted through a write that is a function of a publish object (for example, p_foodataWriter->write(p_foodataWriter, dFoo, 0)). The data may be transmitted through the middleware without having to know who the target is.

Likewise, at a subscriber side, the type of data to be received may be defined based on ‘MDSTypedata_mds;,MDSTypedatakey_mds;’, and then a setting for communication may be made, and then the data may be subscribed based on a take (take is a function of a subscribe object) (for example, p_datareader->take(p_datareader, & fseq, & sseq, 1, ANY_SAMPLE_STATE, ANY_VIEW_DTATE, ANY_INSTANCE_STATE). After the take, it may be determined whether or not the data is necessary data, and then the data may be used.

The subscriber side receives a topic called MDSType in this case, but the subscriber side may receive other types of topic instead. When it is set to receive another type of topic, after the take is called, another type of topic may be received.

As illustrated in FIG. 3, in DDS, the publisher side has only to publish a topic without having to care about the state or data type of a client, and the subscriber side may receive what it is interested in regardless of what the publisher side publishes, thus providing convenience to the application programmer.

Application programs or communication participants that use DDS communication may all require or provide different QoS when performing communication. That is, regarding DDS based data transmission, they may all have different capabilities in guaranteeing a certain level of QoS. In the current DDS standard, there is no method for determining QoS based on a QoSProfile, and thus there is difficulty in setting QoS due to the diversity of QoS configurations, which is a problem. Therefore, there needs to be a method for selecting a QoSProfile that operates the best in accordance with a current network environment in order to provide the QoS required by an application program.

Hereinbelow, a method for generating and applying a QoSProfile related to DDS will be explained. A method for classifying and combining a necessary QoS package and a method for defining a QoSRelation that states QoS will be explained. Furthermore, a method for selecting a QoSProfile that operates the best in accordance with a current network environment will be explained. An application program or communication participant that uses DDS communication in the proposed QoSProfile determining method may not only easily set QoS but also select the best QoS in a current network environment and guarantee a certain data transmission performance regarding data transmission.

In a QoSProfile, a QoS package necessary to satisfy various types of QoS and a relationship between QoS packages may be defined. Furthermore, in a QoSProfile, a method for finding the best QoSProfile agreement conditions in accordance with a network environment may be defined.

For example, a QoSProfile may largely consist of a QoSFunction, QoSMatching, QoSProfile, QoSStatement, QoSConstraint, and QoSCharacteristic.

FIG. 4 is a conceptual view illustrating a QoSProfile of DDS according an embodiment of the present invention.

Referring to FIG. 4, the QoSFunction 400 may provide a function of supporting QoS defined based on the QoSProfile 420.

The QoSMatching 410 may provide a function of searching and selecting the best QoSProfile 420 in accordance with a current network environment.

The QoSProfile 420 may define a QoSRelation that states QoS. QoS may be stated based on the QoSStatement 430. A plurality of QoSContraints 440 may specify conditions that constrain the QoSCharacteristic 450 and include an attribute value regarding the constraint conditions.

The QoSCharacteristic 450 may represent an attribute value regarding a QoSPolicy used in a DDS domain. Each of the elements will be disclosed hereinbelow in detail.

The QoSFunction 400 is the best service that the QoSProfile 420 provides. The QoSFunction 400 may be used to define and construct a relationship between necessary QoS packages of among complicated and various QoS packages, and then to support the best QoSProfile policy that can be satisfied in a current network situation. That is, a certain level of QoS related to data transmission may be guaranteed based on the QoSFunction 400.

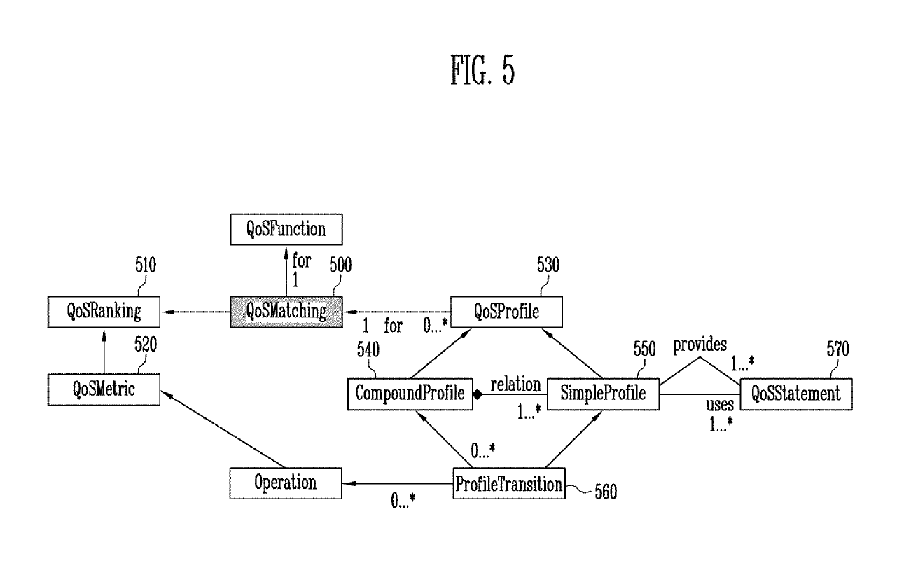

FIG. 5 is a conceptual view illustrating a QoSMatching according to an embodiment of the present invention.

Referring to FIG. 5, the QoSMatching 500 may provide a function of selecting the best QoSProfile 530 in a current network from a plurality of QoSProfiles 530. The QoSMatching 500 may be performed to determine a ranking of QoSProfiles 530 by measuring QoS for each QoSProfile 530 in a network environment where the QoSProfile 530 is applied and a data distribution service is operated.

The QoSRanking 510 may be used to select the QoSProfile 530 that is most suitable in the current network environment by giving scores regarding a QoSSatisfaction index through a QoSMetric 520 and then filtering a lowest profile and putting weight to profiles having high scores.

Referring to FIG. 5, the QoSProfile 530 may include information on an agreement regarding a QoS relationship and on agreement conditions. The QoS relationship may be divided into 3 parts as follows:

(1) ‘For’ is a relationship with a QoSComponent that provides QoS pronounced in the QoSProfile 530.

(2) ‘Provides’ is a relationship with a QoSStatement 570 expected to satisfy QoS.

(3) ‘Uses’ is a relationship with a QoSStatement 570 that must be possessed to satisfy the QoSProfile 530.

The QoSProfile 530 may be classified into 1) a SimpleProfile 550 and 2) CompoundProfile 570. The SimpleProfile 550 includes a simple type QoSStatement 570 that QoS provides. On the other hand, the CompoundProfile 570 may provide two or more simple profiles 550 each using different type of QoS. The CompoundProfile 540 may change the QoSProfile dynamically in accordance with the environment through a ProfileTransition 560 in a run time environment. The ProfileTransition 560 provides an operation to a QoSComponent in a call-back format, enabling responding to the dynamic changes required by an application.

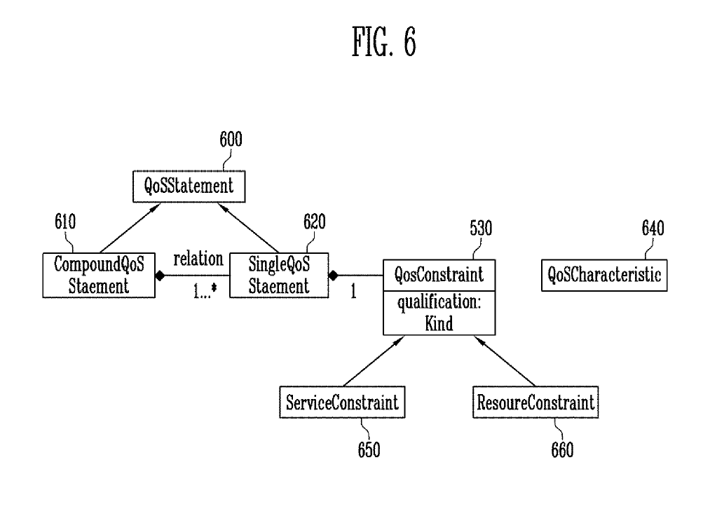

FIG. 6 is a conceptual view illustrating a QoSStatement according to an embodiment of the present invention.

Referring to FIG. 6, a QoSProfile may be classified into a QoSProvider and QoSUser, and it may be expressed as a QoSStatement 600.

Referring to FIG. 6, the QoSStatement 600 is classified into 1) a SingleQoSStatement 620 and 2) a CompoundQoSStatement 610. The SingleQoSStatement has only one QoSConstraint 630 whereas the CompoundQoSStatement 610 may have a relationship with numerous SingleQoSStatements 620. The CompoundQoSStatement 610 may have a relationship combination of “and” or “or” with QoSStatements 600 that the SingleQoSStatement 620 has, and it may be expressed in a Boolean expression.

The QoSConstraint 630 may specify a condition that constrains the QoSCharacteristic 640 and include an attribute value regarding the constraint condition. For example, constraint conditions regarding reliability may be classified into best-effort, threshold, best-effort, semi reliability, and strict reliability. The QoSConstraint 630 may have a ServiceConstraint (certain constraint conditions of application services) 650 and ResourceConstraint (certain constraint conditions of system resources) 660.

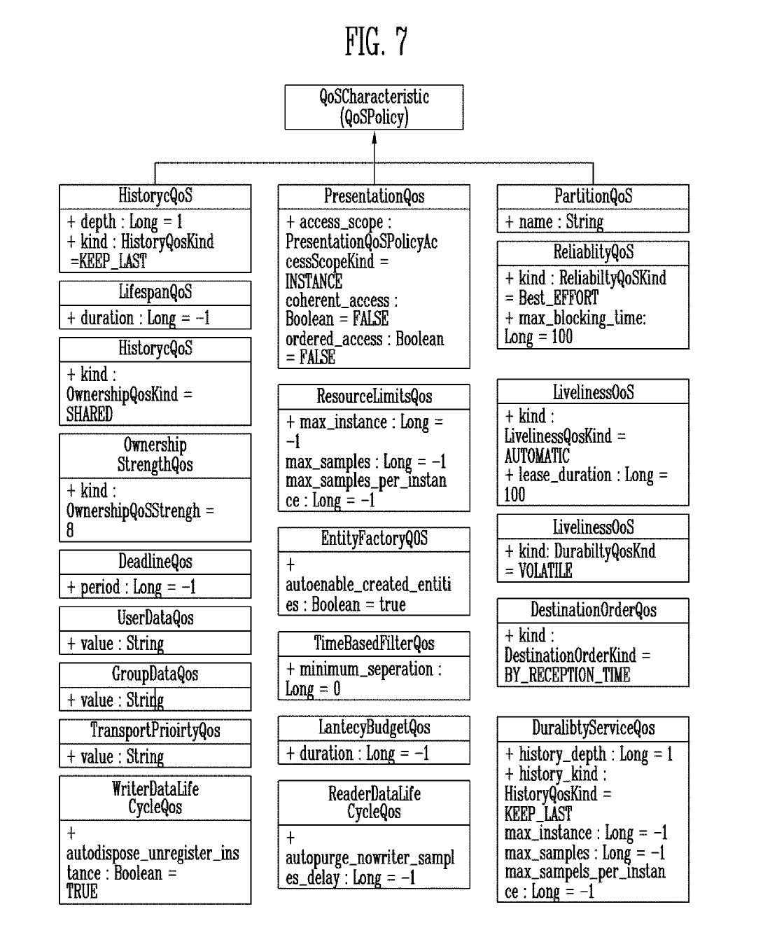

FIG. 7 is a conceptual view illustrating a QoSCharacteristic according to an embodiment of the present invention.

FIG. 7 illustrates examples of an attribute value regarding 21 types of QoSPolicies expressed in DDS.

Referring to FIG. 7, the QoSCharacteristic may be defined based on a QoSPolicy.

A DDS middleware may guarantee communication quality of real time communication between a plurality of entities and high reliability service through a QoSPolicy. DDS Specification (DCPS ver. 2.1) made by OMG defines 22 types of QoS. These QoS are classified into 6˜7 by different categories, each of which operates either independently or mutually with other QoS.

Table 1 below is a list of QoSPolicies.

TABLE 1
QoS Policy

| | |
|---|---|
| DURABILITY | USER DATA |
| HISTIRY | GROUP DATA |
| READER LIFECYCLE | TOPIC DATA |
| WRITER LIFECYCLE | PARTITION |
| LIFESPAN | PRESENTATION |
| ENTITY FACTORY | DESTINATION ORDER |
| RESOURCE LIMITS | OWNERSHIP |
| RELIABILITY | OWNERSHIP STRENGTH |
| TIME BASEDFILTER | LIVELINESS |
| DEADLINE | LATENCY BUDGET |
| CONTENT FILTERS | TRANSPORT PRIORITY |

Characteristics of DDS QoS may be expressed by Concern (subject of application of QoS), RxO (relationship between subjects of application of QoS), and Changeable (whether or not to change QoS).

Concern is a value that represents the subjects where QoS is to be applied, and the subjects may include a Topic, DataWriter, DataReader, Publisher, Subscriber, DomainParticipant, and DomainParticipantFactory. Depending on the characteristics of QoS, the value of Concern, that is the subjects of application may be one, or more than one.

For example, the QoS ‘READER LIFECYCLE’ can be applied to a DataReader only, and ‘DEADLINE’ may be applied to a Topic, DataWriter, and DataReader.

RxO is an abbreviation for Requested/Offered, which may express a mutual relationship between a publisher/transmission side and subscriber/reception side. When RxO is ‘YES’, QoS may be applied to both a publisher side and subscriber side, and the set QoS value that has may be used compatibly. When RxO is ‘No’, QoS must be applied to both the publisher side and subscriber side, but the set QoS value may be independent from each other. When RxO is ‘N/A’, QoS may be applied to only one of the publisher side and subscriber side.

For example, a QoSPolicy ‘DEADLINE’ has RxO of a ‘YES’ value. That is, the QoSPolicy ‘DEADLINE’ is QoS that must be applied to both sides, and under a condition ‘offered deadline period<=requested deadline period’, the ‘DEADLINE’ period of the publisher side may have a shorter value than the ‘DEADLINE’ period of the subscriber side.

Changeable (or modifiable) may be used to instruct whether or not to change QoS. Each value of QoS is determined as an object to be applied is generated, and when Changeable is ‘YES’, a QoS value may be changed while operating, but when Changeable is ‘NO’, a QoS value cannot be changed once it is generated. For example, RESOURCE_LIMITS determines an allocation amount of resources necessary in an object, and when Changeable of RESOURCE_LIMITS is ‘NO’, a value set for the allocation amount of resources cannot be set again once a service starts.

Hereinbelow, some QoSPolicies, RELIABILITY, HISTORY, DURATION, OWNERSHIP, PARTITION, DEADLINE, and TIME_BASED_FILTER will be explained.

In the table below, ‘T’ indicates TOPIC, ‘DR’ indicates DataReader, ‘DW’ indicates DataWriter, ‘P’ indicates Publisher, and ‘S’ indicates Subscriber.

TABLE 2

| Qos Policy | Applicability | RxO | Midifiable |
|---|---|---|---|
| RELIABILITY | T, DR, DW | Y | N |

Table 2 shows a QoSPolicy, RELIABILITY.

‘RELIABILITY’ may set two attributes and determine a reliability level (whether or not to retransmit) of data communication. ‘RELIABLE’ which is a first attribute of ‘RELIABILITY’ may guarantee all samples in a DataWriter History being transmitted to a DataReader. ‘BEST_EFFORT’ which is a second attribute of ‘RELIABILITY’ does not retransmit data samples lost during communication and maintains the order of data.

TABLE 3

| Qos Policy | Applicability | RxO | Midifiable |
|---|---|---|---|
| HISTORY | T, DR, DW | N | N |

Table 3 shows a QoSPolicy, HISTORY.

HISTORY may set two attributes and determine a past data storage method in a HistoryCache for retransmission of data (retransmission to an application). ‘KEEP_LAST’ which is a first attribute of HISTORY may maintain the latest data of as much as the size of Depth (the number of data maintained in the HistoryCache). ‘KEEP_ALL’ which is a second attribute of HISTORY may maintain and transmit all values of instance to the DataReader.

TABLE 4

| Qos Policy | Applicability | RxO | Midifiable |
|---|---|---|---|
| DURABILITY | T, DR, DW | Y | N |
| DURABILITY SERVICE | T, DW | N | N |

Table 4 shows a QoSPolicy, DURABILITY.

DURABILITY may set four types of attributes and determine whether or not to transmit previous data to a DataReader that participated later. ‘VOLATILE’ which is a first attribute of DURABILITY may provide only data generated after a connection was set. ‘TRANSIENT LOCAL’ which is a second attribute of DURABILITY may coincide with the lifecycle of a DataWriter. ‘TRANSIENT’ which is a third attribute of DURABILITY may provide past data to the DataReader. ‘PERSISTENT’ which is a fourth attribute of DURABILITY may store past data in a Permanent-Storage, and the effectiveness of the data may last longer than the system.

TABLE 5

| Qos Policy | Applicability | RxO | Midifiable |
|---|---|---|---|
| OWNERSHIP | T, DR, DW | Y | N |

Table 5 shows a QoSPolicy, OWNERSHIP.

OWNERSHIP may determine whether or not to allow a plurality of DataWriters to renew the same instance. ‘SHARED’ which is a first attribute of OWNERSHIP may allow a plurality of DataWriters to update the same datainstance. ‘EXCLUSIVE’ which is a second attribute of OWNERSHIP may allow each instance of a data object to be modifiable by only one DataWriter.

TABLE 6

| Qos Policy | Applicability | RxO | Midifiable |
|---|---|---|---|
| PARTITION | P, S | Y | N |

Table 6 shows a QoSPolicy, PARTITION.

PARTITION may determine a method for separating nodes inside a domain. That is, it may form a separate logical communication channel in the domain. Data distribution is possible between a DataWriter/DataReader having the same Partition Name. The difference between Partition and Domain is that objects belonging to different domains are completely independent from one another, whereas entities may be in a plurality of partitions while still belonging to only one domain.

TABLE 7

| Qos Policy | Applicability | RxO | Midifiable |
|---|---|---|---|
| DEADLINE | T, DR, DW | Y | Y |

Table 7 shows a QoSPolicy, DEADLINE.

DEADLINE may define a maximum arrival time between data samples. A DataWriter may transmit data at least once within the time where a DEADLINE (period:Duration_t) is set. If data is not received from the DataWriter within the DEADLINE (period:Duration_t), a DataReader may be notified of violation from DDS.

TABLE 8

| Qos Policy | Applicability | RxO | Midifiable |
|---|---|---|---|
| TIME BASED FILTER | DR | N/A | Y |

Table 8 shows a QoSPolicy, TIME BASED FILTER.

A DataReader may determine the time for filtering data based on TIME BASED FILTER. By setting Minimum_separation:Duation_t, the DataReader may delete data received within a set value.

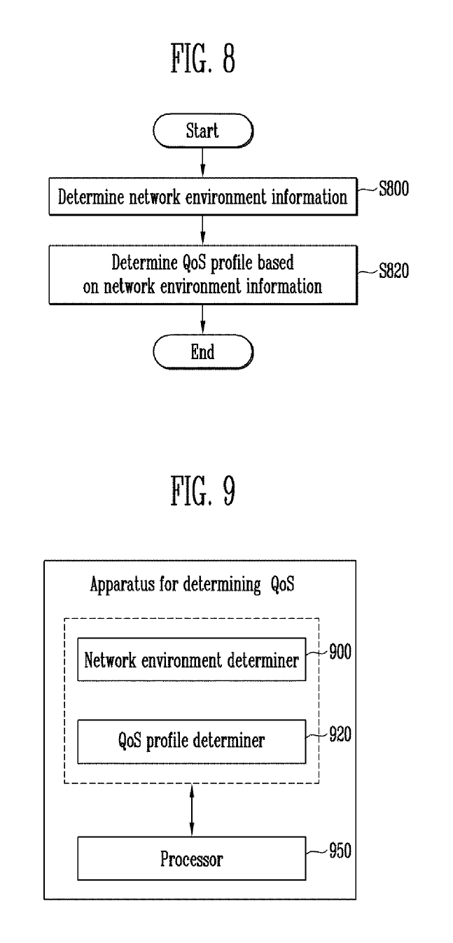

FIG. 8 is a flowchart illustrating a method for determining QoS according to an embodiment of the present invention.

Referring to FIG. 8, network environment information is determined (S800).

According to an embodiment of the present invention, network environment information may be determined in order to determine QoS. The network environment information may include the QoS required by an application and a current state of network and so forth. That is, regarding DDS based data transmission, in order to guarantee a certain level of QoS and provide the QoS required by an application program, a QoSProfile that operates the best in accordance with the current network environment may be selected.

A QoSProfile is determined based on the network environment information (S820).

In order to satisfy various kinds of QoS in a DDS communication middleware, a profile to be used in a data distribution service may be determined based on the QoSFunction, QoSMatching, QoSProfile, QoSStatement, QoSConstraint, and QoSCharacteristic explained with reference to FIGS. 4 to 6. In this method, it is possible to easily classify and combine QoS that is required by an application and select a QoSProfile that operates the best in accordance with a current network environment. Therefore, by applying the best QoSProfile selected, it is possible to guarantee optimal performance while satisfying various QoS requirements related to data transmission.

FIG. 9 is a conceptual view illustrating an apparatus for determining QoS according to an embodiment of the present invention.

Referring to FIG. 9, an apparatus for determining QoS may include a network environment determiner 900, QoSProfile determiner 920, and processor 950.

The network environment determiner 900 may be configured to determine network environment information. The network environment determiner 900 may determine network environment information for determining QoS (QoS required by an application and a current state of network).

The QoSProfile determiner 920 may determine a QoSProfile based on the network environment information. The QoSProfile determiner 820 may determine a profile to be used in a data distribution service based on the QoSFunction, QoSMatching, QoSProfile, QoSStatement, QoSConstraint, and QoSCharacteristic illustrated with reference to FIGS. 4 to 7 in order to satisfy various kinds of QoS in a DDS communication middleware.

The processor 950 may be configured to control operations of the network environment determiner 900 and QoSProfile determiner 920.

In the drawings and specification, there have been disclosed typical exemplary embodiments of the invention, and although specific terms are employed, they are used in a generic and descriptive sense only and not for purposes of limitation. As for the scope of the invention, it is to be set forth in the following claims. Therefore, it will be understood by those of ordinary skill in the art that various changes in form and details may be made therein without departing from the spirit and scope of the present invention as defined by the following claims.

What is claimed is:

1. A method for determining a QoS (quality of service) profile in the data distribution service, the method comprising:
determining network environment information; and
determining the QoSProfile based on the network environment information,
wherein the QoSProfile comprises a QoSFunction, QoS Matching, QoSStatement, QoSConstraint, and QoSCharacteristic.

2. The method according to claim 1,
wherein the QoSFunction determines the QoSCharacteristic based on the network environment information.

3. The method according to claim 2,
wherein the QoSMatching determines a QoSRanking by measuring how much each QoSProfile satisfies QoS in a network environment where the QoSProfile is applied and a service is operated, and
the QoSRanking is computed by giving scores regarding a QoS satisfaction index through a QoSMetric.

4. The method according to claim 3,
wherein the QoSStatement is classified into a SingleQoSStatement and CompoundQoSStatement,
the SingleQoSStatement has only one QoSConstraint,
the CompoundQoSStatement has a relationship combination of ‘and’ or ‘or’ with a plurality of SingleQoSStatements, and
the QoSConstraint comprises a condition that constrains the QoSCharacteristic, and an attribute value regarding the condition.

5. The method according to claim 4,
wherein the QoSCharacteristic represents an attribute value regarding a QoSPolicy,
the QoSPolicy is defined to guarantee communication quality of real time communication between a plurality of entities, and
the QoSPolicy comprises information on an object where QoS is applied, and information regarding whether or not QoS is changeable.

6. An apparatus for determining a QoS (Quality of Service) profile in the data distribution service, the apparatus comprising:
a processor configured to determine network environment information,
the apparatus being configured to determine the QoSProfile based on the network environment information,
the QoSProfile comprising a QoSFunction, QoSMatching, QoSStatement, QoSConstraint, and QoSCharacteristic.

7. The apparatus according to claim 6,
wherein the QoSFunction determines the QoSCharacteristic based on the network environment information.

8. The apparatus according to claim 7,
wherein the QoSMatching determines a QoSRanking by measuring how much each QoSProfile satisfies QoS in a network environment where the QoSProfile is applied and a service is operated, and
the QoSRanking is computed by giving scores regarding a QoS satisfaction index through a QoSMetric.

9. The apparatus according to claim 8,
wherein the QoSStatement is classified into a SingleQoSStatement and CompoundQoSStatement,
the SingleQoSStatement has only one QoSConstraint,
the CompoundQoSStatement has a relationship combination of ‘and’ or ‘or’ with a plurality of SingleQoSStatements, and
the QoSConstraint comprises a condition that constrains the QoSCharacteristic, and an attribute value regarding the condition.

10. The apparatus according to claim 9,
wherein the QoSCharacteristic represents an attribute value regarding a QoSPolicy,
the QoSPolicy is defined to guarantee communication quality of real time communication between a plurality of entities, and
the QoSPolicy comprises information on an object where QoS is applied, and information regarding whether or not QoS is changeable.
